(19) United States
(12) Patent Application Publication
(10) Pub. No.: US 2017/0116668 A1
(43) Pub. Date: Apr. 27, 2017

(54) WASTE MANAGEMENT SYSTEM HAVING ANTICIPATORY CONTROL

(71) Applicant: Rubicon Global Holdings, LLC, Altanta, GA (US)

(72) Inventor: Philip RODONI, Decatur, GA (US)

(73) Assignee: Rubicon Global Holdings, LLC, Altanta, GA (US)

(21) Appl. No.: 15/185,771

(22) Filed: Jun. 17, 2016

Related U.S. Application Data
(60) Provisional application No. 62/246,503, filed on Oct. 26, 2015.
(60) Provisional application No. 62/297,839, filed on Feb. 20, 2016.

(51) Int. Cl. G06Q 30/08; G06Q 20/10; H04W 4/02; G06Q 10/06

(52) U.S. Cl. CPC G06Q 30/08; G06Q 10/06313; G06Q 20/102; H04W 4/02; G06Q 10/06315; G06Q 50/10

(57) ABSTRACT

A management system is disclosed for use with a vehicle configured to receive waste from a receptacle. The management system may have at least one sensor mountable onboard the vehicle and configured to generate a receptacle-specific signal indicative of a condition of the receptacle. The management system may also have a controller in communication with the at least one sensor. The controller may be configured to receive information that is non-specific to the receptacle, to anticipate a service need of the receptacle based on the receptacle-specific signal and the information, and to selectively direct the vehicle to service the waste receptacle based on the service need.

### RELATED APPLICATIONS

This application is based on and claims priority to U.S. Provisional Application Nos. 62/246,503 filed on Oct. 26, 2015; and 62/297,839 filed on Feb. 20, 2016, the contents of all of which are expressly incorporated herein by reference.

### TECHNICAL FIELD

The present disclosure relates generally to a management system and, more particularly, to a waste management system having anticipatory control.

### BACKGROUND

Conventional waste removal companies employ fleets of vehicles to retrieve waste from customer locations (e.g., from a retail store, a factory, a government building, or a residential address) having contracts with the company. The vehicles are dispatched to retrieve the waste on a regularly scheduled basis, or only when contacted by the customer. In some instances, when the vehicles are dispatched to retrieve the waste, the corresponding waste receptacles are less than full. In other instances, the waste receptacles are overflowing by the time the vehicles are dispatched. In yet other instances, although the receptacles may not be full, the waste in the receptacles may be creating problems for the customer because of how long the waste has been in the receptacles awaiting retrieval. In each of these instances, the customer may be less than satisfied with the provided service.

One attempt to address the above-described problems is disclosed in U.S. Pat. No. 7,406,402 (“the '402 patent”). Specifically, the '402 patent discloses a system for scheduling the emptying of a waste container. The system includes a remote status unit coupled with a pressure transducer of an associated compacting ram, and a central unit. Each time material in the waste container is compacted by the compacting ram, the remote unit communicates information about the event (e.g., a frequency and/or force of the compacting) to the central unit. Based on the compacting information, the central unit determines a fullness of the waste container. Based on a history of the fullness information communicated by the remote unit to the central unit over a period of time, the central unit also predicts when the waste container will become completely full. The central unit then considers customer preferences (e.g., desired pick up times, pick up days, and desired container fullness) and limitations of waste haulers (e.g., number of drivers and trucks, shift structure, driver hours, dispatch hours, lead time, and landfill requirements), when selecting a latest time for dispatching a vehicle to empty the waste container that satisfies both the customer preferences and the waste hauler limitations.

Although the system of the '402 patent may help to avoid premature or delayed waste retrieval, it may also be problematic and lack applicability. In particular, every bin serviced by the system of the '402 patent requires a dedicated pressure transducer and remote unit. This large number of pressure transducers and remote units may be expensive to procure and difficult to maintain. In addition, the system may not consider a sufficient set of factors that may affect the fill rate of the waste containers to provide accuracy in the completely-full prediction. Further, the system may be applicable only to waste containers having compacting rams.

The disclosed system is directed to overcoming one or more of the problems set forth above and/or other problems of the prior art.

### SUMMARY

In one aspect, the present disclosure is directed to a management system for use with a vehicle configured to receive waste from a receptacle. The management system may include at least one sensor mountable onboard the vehicle and configured to generate a receptacle-specific signal indicative of a condition of the receptacle. The management system may also include a controller in communication with the at least one sensor. The controller may be configured to receive information that is non-specific to the receptacle, to anticipate a service need of the receptacle based on the receptacle-specific signal and the information, and to selectively direct the vehicle to service the receptacle based on the service need.

In another aspect, the present disclosure is directed to method for managing service of a waste receptacle by a vehicle. The method may include sensing from onboard the vehicle a condition of the waste receptacle, and receiving information that is non-specific to the waste receptacle. The method may also include automatically anticipating a service need of the waste receptacle based on the condition and the information, and selectively directing the vehicle to the waste receptacle based on the service need.

In yet another aspect, the present disclosure is directed to a non-transitory computer readable medium containing computer-executable programming instructions for performing a method of management of a waste receptacle by a vehicle. The method may include sensing from onboard the vehicle a condition of the waste receptacle, and receiving information that is non-specific to the waste receptacle including at least one of a weather condition, a traffic condition, a sales event, a holiday, or a demographic condition. The method may also include determining a fill rate of the waste receptacle based on the condition sensed over a period of time, and automatically anticipating a service need of the waste receptacle based on the condition, the fill rate, and the information.

### BRIEF DESCRIPTION OF THE DRAWINGS

FIG. 1 is an isometric illustration of an exemplary disclosed waste management environment;

FIG. 2 is a diagrammatic illustration of an exemplary disclosed system that may be used to manage the environment of FIG. 1; and

FIG. 3 is a flowchart depicting an exemplary disclosed method that may be performed by the system of FIG. 2.

### DETAILED DESCRIPTION

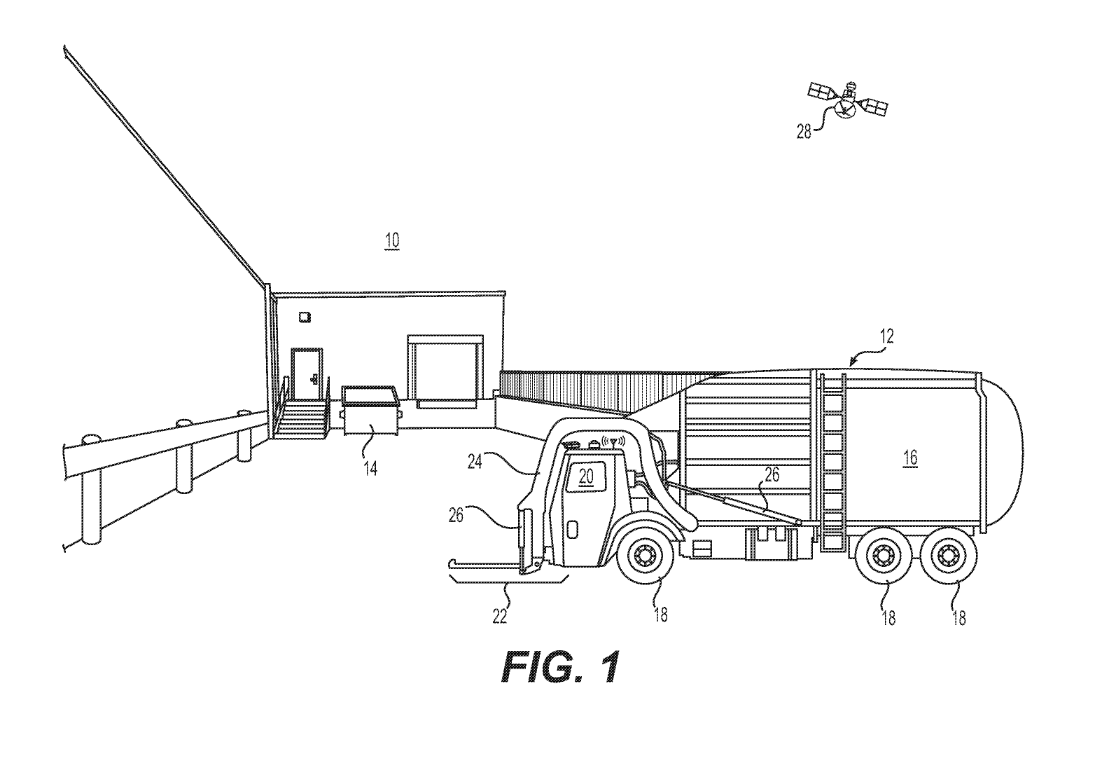

FIG. 1 illustrates an exemplary waste management environment (“environment”) 10, at which a vehicle 12 is providing service. Environment 10 may include a retail store, a factory, a government building, a residential address, or another location having one or more receptacles 14 that require the service of vehicle 12. The service may include, for example, the removal of waste materials from inside of receptacle(s) 14, the replacement of receptacle(s) 14, and/or the placement of additional receptacles 14.

Vehicle 12 may take many different forms. In the example of FIG. 1, vehicle 12 is a hydraulically actuated, front-loading type of vehicle. Specifically, vehicle 12 may include a bed 16 supported by a plurality of wheels 18, a cab 20 located forward of bed 16, and a lifting device 22 extending forward of cab 20. Lifting device 22 may consist of, among other things, one or more lift arms 24 configured to engage and/or grasp receptacle 14, and one or more actuators 26 powered by pressurized oil to raise lift arms 24 (and receptacle 14) up past cab 20 to a dump location over bed 16. After dumping of receptacle 14, pressurized oil may be released from hydraulic actuator(s) 26 to allow lowering of lift arms 24 and receptacle 14 back to the ground in front of vehicle 12.

In other examples, lifting device 22 may be located to pick up and dump receptacles 14 from a side and/or a rear of vehicle 12, or to simply load receptacles 14 onto vehicle 12 for transportation away from environment 10. In yet other examples, receptacles 14 may be manually lifted and dumped into bed 16. In any of these examples, bed 16 could be outfitted with a compactor (not shown) to compact the waste material after the material is dumped into bed 16, and/or a door (not shown) configured to close an opening of bed 16 through which the waste material is dumped. Other configurations may also be possible.

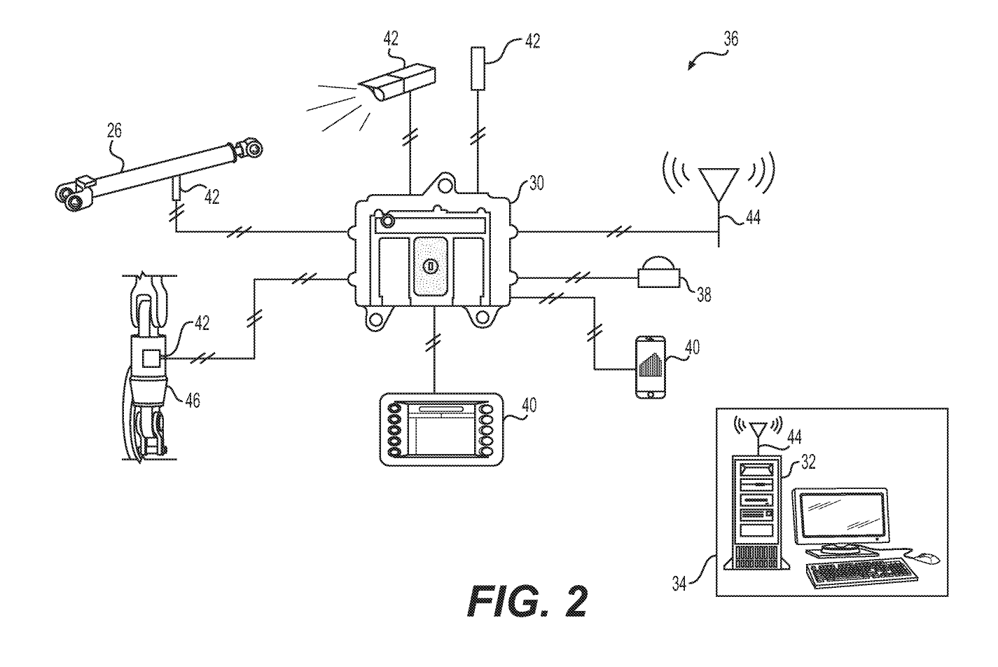

As vehicle 12 moves about environment 10, a satellite 28 or other tracking device may communicate with an onboard controller 30 (shown only in FIG. 2) to monitor the movements of vehicle 12 and the associated changes made to environment 10 (e.g., receptacle pickup, dumping, placement, etc.). As will be explained in more detail below, onboard controller 30, or a separate offboard controller 32 (e.g., a controller 32 located in a back office 34 or other service facility—shown only in FIG. 2), may then manage future operations of vehicle 12 based on these movements and changes.

Both of onboard and offboard controllers 30, 32 may include means for monitoring, recording, storing, indexing, processing, communicating and/or controlling other onboard and/or offboard devices. These means may include, for example, a memory, one or more data storage devices, a central processing unit, or any other components that may be used to run the disclosed application. Furthermore, although aspects of the present disclosure may be described generally as being stored in memory, one skilled in the art will appreciate that these aspects can be stored on or read from different types of computer program products or non-transitory computer-readable media such as computer chips and secondary storage devices, including hard disks, floppy disks, optical media, CD-ROM, or other forms of RAM or ROM.

As shown in FIG. 2, onboard controller 30 may form a portion of a waste management system (“system”) 36 that is configured to track, assist, and/or control movements of vehicle(s) 12. In addition to onboard controller 30, system 36 may also include a locating device 38, and at least one of an input device 40 and a sensor 42 mounted or otherwise located onboard each vehicle 12. In some embodiments, system 36 includes both manual input device 40 and one or more sensors 42. Onboard controller 30 may be in communication with each of these other components and/or with offboard controller 32 at back office 34 (e.g., via a communication device 44), and configured to determine, based on signals from these components and based on other known information stored in memory, the location of each vehicle 12, and characteristics and locations of receptacles 14 being moved by and/or in a vicinity of each vehicle 12. It is contemplated that any two or more of the components of system 36 could be assembled into a single device (e.g., a smartphone, tablet, or vehicle console), as desired. If housed separately, the components of system 36 may be connected via a wireless or wired connection.

Locating device 38 may be configured to generate signals indicative of a geographical position and/or orientation of vehicle 12 relative to a local reference point, a coordinate system associated with environment 10, a coordinate system associated with Earth, or any other type of 2-D or 3-D coordinate system. For example, locating device 38 may embody an electronic receiver configured to communicate with satellites 28 (referring to FIG. 1), or a local radio or laser transmitting system used to determine a relative geographical location of itself. Locating device 38 may receive and analyze high-frequency, low-power radio or laser signals from multiple locations to triangulate a relative 3-D geographical position and/orientation. In some embodiments, locating device 38 may also be configured to determine a location and/or orientation of a particular part of vehicle 12, for example of lift arms 24 (shown only in FIG. 1). Based on the signals generated by locating device 38 and based on known kinematics of vehicle 12, onboard controller 30 may be able to determine in real time the position, heading, travel speed, acceleration, and/orientation of vehicle 12 and lift arms 24. This information may then be used by onboard and/or offboard controllers 30, 32 to update the locations and conditions of vehicles 12 and/or receptacles 14 in an electronic map or database of environment 10.

Input device 40 may provide a way for an operator of vehicle 12 to input information regarding observances made while traveling around environment 10. For example, the operator may be able to enter a type and/or condition of waste observed at a particular location, an amount of waste in or around receptacle 14, a fill status of a particular receptacle 14, a condition of receptacle 14, a location of receptacle 14, and/or other information about receptacle 14 and waste engaged by, loaded into, or otherwise processed by vehicle 12. The information may be input in any number of ways, for example via a cab-mounted touch screen interface, via one or more buttons, via a keyboard, via speech recognition, via a smart phone carried by the operator, or in another manner known in the art. In some embodiments, in addition to receiving manual input from an operator, input device 40 may also be capable of displaying information, for example the electronic map of environment 10, instructions from back office 34, payload information, cycle count, etc.

Sensors 42 may be configured to monitor parameters associated with the waste material loaded into vehicle 12 and/or the associated receptacles 14 being moved by vehicle 12 (e.g., moved by lift arms 24), and to generate corresponding signals indicative thereof. Each of these sensors 42 may be any type of device known in the art, and located anywhere on vehicle 12. In one example, sensor 42 may embody any one or more of a load cell, a force gauge, a pressure sensor, or another type of load detector associated directly with lift arms 24, with actuator(s) 26, and/or with a strut 46 supporting bed 16. In this example, the signals generated by sensor(s) 42 may correspond with strain on lift arms 24, with a force applied to lift arms 24 by actuator(s) 26, and/or with a payload weight of receptacle 14 or bed 16.

Alternatively, one or more sensors 42 may be associated with a power source or drivetrain of vehicle 12, and configured to generate signals indicative of an amount of power used to propel vehicle 12, to drive the hydraulics of actuators 26, to move the in-bed compactor, or to shut the associated door. Other types of sensors 42 (e.g., cameras, spectrometers, IR sensors, RADAR sensors, LIDAR sensors, etc.) may also be utilized to determine characteristics (e.g., load profile, volume, and/or shape) of the waste material inside receptacles 14 or of receptacles 14 themselves. In yet further examples, sensor 42 could be an accoustic sensor (e.g., a microphone), an accelerometer, a gyroscope, or another similar type of sensor configured to detect engagement conditions and/or cycle completion of lift arms 24, the in-bed compactor, the door, etc. during lifting, dumping, and/or shaking of receptacle 14. Other types of sensors 42 may alternatively or additionally be utilized. Signals generated by these sensors 42 may be communicated to onboard and/or offboard controllers 30, 32, and the appropriate controller may use the signals to determine the conditions surrounding receptacles 14 (and/or the waste inside receptacles 14) during servicing by vehicle 12.

Onboard controller 30 may be configured to manage communications between other onboard components and offboard controller 32 located at back office 34. For example, onboard controller 30 may receive signals from locating device 38, input device(s) 40, and sensors 42, and correlate the signals, filter the signals, buffer the signals, record the signals, or otherwise condition the signals before directing the signals offboard via communication device 44.

Communication device 44 may be configured to facilitate communication between onboard controller 30 and offboard controller 32. Communication device 44 may include hardware and/or software that enable the sending and/or receiving of data messages through a communications link. The communications link may include satellite, cellular, infrared, radio, and any other type of wireless communications. Alternatively, the communications link may include electrical, optical, or any other type of wired communications, if desired. In one embodiment, onboard controller 30 may be omitted, and offboard controller 32 may communicate directly with locating device 38, input device(s) 40, and/or sensor(s) 42 via communication device 44, if desired. Other means of communication may also be possible.

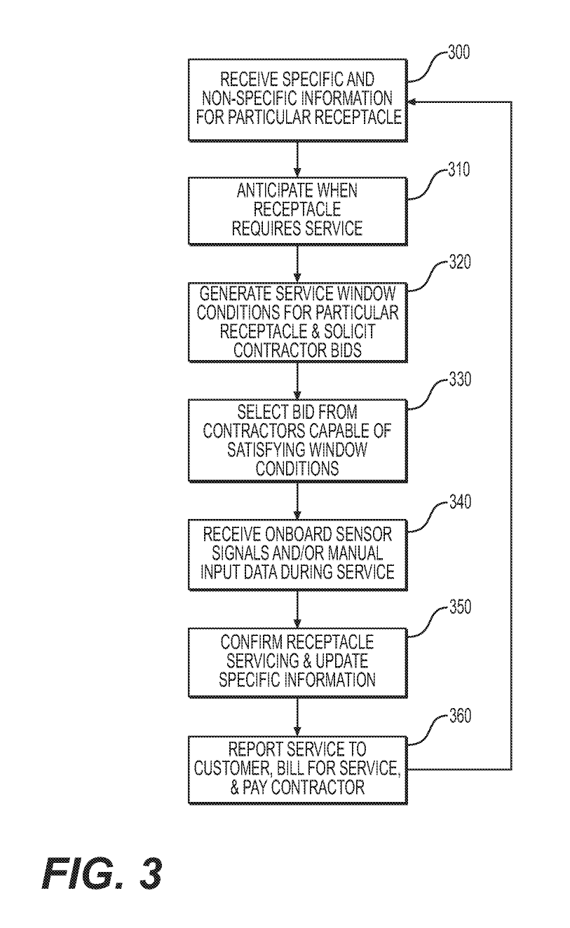

Onboard and/or offboard controllers 30, 32, based on the information received from onboard vehicles 12 and also based on information received from other sources (e.g., via the internet, via manual input at back office 34, etc.), may be configured to execute instructions stored on computer readable medium to perform methods of waste management at environment 10. For example, onboard and/or offboard controllers 30, 32 may be configured to anticipate a service window for a particular receptacle (e.g., a window of time within which the particular receptacle 14 should be serviced), and to arrange for a hauling contractor to provide the required service. This process is illustrated in FIG. 3, and will be explained in more detail in the following section to further illustrate the disclosed concepts.

### INDUSTRIAL APPLICABILITY

The disclosed system may be applicable to the waste service industry, where numerous waste receptacles 14 are distributed across multiple locations, each having varying service requirements. The disclosed system may consider receptacle specific information and receptacle non-specific information in order to anticipate the future needs of the different locations. The disclosed system may then manage fleet resources to meet anticipated service needs in an efficient, profitable manner. Operation of system 36 will now be described with reference to FIG. 3.

As shown in FIG. 3, operation of system 36 may begin with onboard and/or offboard controllers 30, 32 receiving the receptacle specific and receptacle non-specific information for a particular receptacle (Step 300). The receptacle specific information may be information related to the particular receptacle that remains true, regardless of external conditions. This information may include, for example, who the owner or lessee of the receptacle is; a physical address of the owner/lessee (or where the receptacle is located); a designated position and/or orientation at the address of where the receptacle is to be placed; a size, shape, volume, and/or empty weight of the receptacle; a co-location of the receptacle with other receptacles; a usage history of the receptacle at the location; and customer preferences for service of the receptacle. The usage history may include, among other things, a fill rate, a time required for the receptacle to become completely full, a weight of the completely full receptacle, a type of waste material deposited in the receptacle, and trends (e.g., seasonal-based changes, economic-based changes, weather-based changes, and other similar changes) associated with the other usage history information. The customer preferences may include, among other things, preferred days on which the particular receptacle should be serviced, preferred hours of servicing, preferred fill thresholds (e.g., minimum and/or maximum amounts of waste that must be in the receptacle) before servicing, preferred travel paths and/or access points to the receptacle, etc. The receptacle specific information may be manually entered information (e.g., information entered from onboard vehicle 12 via input device(s) 40 and/or entered at back office 34) or information that is automatically entered (e.g., information obtained via onboard sensor(s) 42). The information may be entered continuously (e.g., as it is received) or periodically (e.g., once each day, at an end of a billing cycle, quarterly, etc.), as desired.

The receptacle non-specific information may be information that varies and is not necessarily linked to the particular receptacle 14. In other words, the receptacle non-specific information is information that is externally obtained relative to receptacle 14. This information may include, for example, business information associated with the location (e.g., a type of business performed at the location, a size of the business, a foot-traffic count, a sales volume, a scheduled sale or promotional event, yearly financial fluctuations, renovation schedules, expansion schedules, planned shutdowns, business hours, unscheduled changes in business hours, vendor delivery corridors and/or schedules, etc.). The information may also include local or regional information of the area surrounding the location (e.g., a calendar of holidays, weather conditions, traffic or road conditions, seasonal changes, local events, population demographics such as density or spending habits, etc.). The receptacle non-specific information could also include landfill information (e.g., locations, hours, material receiving requirements, fees, etc.). The receptacle non-specific information may be manually entered (e.g., entered from onboard vehicle 12 via input device(s) 40 and/or entered at back office 34), and retrieved or automatically fed from an internet site (e.g., a weather or traffic site) or radio channel. The information may be entered once (e.g., at the start of a new contract with a particular location or landfill), entered continuously (e.g., as it is received, downloaded, or fed into system 36), or entered periodically (e.g., once each day, at an end of a billing cycle, quarterly, etc.), as desired.

Based on the receptacle information (i.e., both the specific and non-specific information) received at step 300, onboard and/or offboard controllers 30, 32 may be configured to automatically anticipate when a particular receptacle 14 will likely require servicing (Step 310). In some instances, service needs may be determined directly based on only customer preference. For example, the customer may indicate a desire for receptacle 14 to be serviced every Tuesday, between the hours of 10:00 pm and 2:00 am, regardless of any other conditions. In another example, a customer may indicate a need for immediate service.

In other instances, however, the customer may request that receptacle 14 be serviced on an as-needed basis, for example when an amount of waste in receptacle 14 exceeds a 75% fill capacity and before receptacle 14 is completely full. In this situation, onboard and/or offboard controllers 30, 32 may compare the receptacle specific information (e.g., past usage history of the particular receptacle 14) with the receptacle non-specific information (e.g., with expected weather conditions, business conditions, traffic conditions, sales events, renovation schedules, holidays, etc.) at the corresponding location in order to anticipate a current fill rate of receptacle 14 and a corresponding date/time when that receptacle 14 should be filled with about 75-100% capacity.

For example, a particular receptacle 14 at a particular location may normally fill at a rate of about 15% per day. Based on this information alone, onboard and/or offboard controllers 30, 32 may anticipate a need for the particular receptacle to be emptied about once per week. However, this service frequency may need to increase or decrease based on external factors that cannot be controlled, in order for customer expectations to be satisfied. Onboard and/or offboard controllers 30, 32 may be configured to determine the influence of the external factors (e.g., based on the non-receptacle specific information), and to responsively adjust the forecast of service frequency for the particular receptacle 14.

For example, based on a weather report of heavy snow, based on a known schedule of renovation, and/or based on a competing local event, onboard and/or offboard controllers 30, 32 may be configured to determine that there will be a likely downturn in foot traffic visiting the location at which the particular receptacle 14 is located. This downturn could result in corresponding reduction in the fill rate of that receptacle 14. In contrast, based on a known sales promotion at the location, a holiday, or improving weather, onboard and/or offboard controllers 30, 32 may determine that the foot traffic and corresponding fill rate are likely to increase. Onboard and/or offboard controllers 30, 32 may utilize an algorithm stored in memory to make these forecasts based on the receptacle specific and receptacle non-specific information.

Onboard and/or offboard controllers 30, 32 may then generate a window of conditions surrounding the anticipated service event, and solicit bids from a plurality of independent hauling contractors to perform the service (Step 320). In some embodiments, the window of conditions may be associated with a single service event (e.g., a one-time emptying of the particular receptacle 14). In other embodiments, the window of conditions may be associated with a number of service events that should take place over a specified period of time. The conditions may include, among other things, a date of the required service, a time of service, a service location, a position of receptacle 14 at the location, permitted travel paths, parameters of receptacle 14 (e.g., a configuration, size, anticipated volume or weight, etc.), parameters of the waste held in receptacle 14 (e.g., a type or condition of the waste material), where the waste material should be taken, weather conditions, traffic conditions, and other conditions known in the art. The window of conditions may be made available (e.g., published on a website, emailed, physically posted, etc.) for all available haul contractors to bid on or for only a selected subset of available haul contractors (e.g., a set of trusted and/or previously hired contractors), as desired.

Once the bids from the haul contractors are received, one of the bids may be selected for contract award (Step 330). In the disclosed embodiment, this selection is performed automatically by onboard and/or offboard controllers 30, 32 based on any number of prioritized stipulations (e.g., rated past performance, speed, quality, cost, availability, etc.). In these automated embodiments, it may still be possible for a human user of system 36 to override the bid selection, if desired. In other embodiments, the selection of bids may be a completely manual process. Once a bid is selected, the service of the particular receptacle 14 may be performed by the corresponding haul contractor according to the window of conditions of the associated receptacle 14.

As service of the particular receptacle 14 is being performed, feedback associated with the service may be provided for use in tuning the algorithm discussed above, billing the customer, rating and paying the haul contractor, and/or making adjustments to future window conditions. This feedback may come from multiple sources. In the disclosed embodiment, real-time feedback is received by onboard and/or offboard controllers 30, 32 from sensors 42 and/or input devices 40 (Step 340). For example, as vehicle 12 approaches the particular receptacle 14, the location of vehicle 12 may be tracked via locating device 38 and compared with the desired travel path, the date, the time of day, etc. In addition, as lift arms 24 engage and/or raise receptacle 14, sensors 42 may generate signals indicative of the engagement, a receptacle weight, a waste volume, completion of a dumping maneuver, a change in receptacle weight, vibrational changes associated with lift arms 24 shaking a full versus empty receptacle 14, an increase in vehicle payload, use of the in-bed compaction ram, opening and/or closing of the bed door, etc.

Onboard and/or offboard controllers 30, 32 may then use the feedback information generated onboard vehicle 12 during servicing to update the receptacle specific data stored in memory, and to confirm that servicing of the particular receptacle 14 was performed (Step 350). For example, based on a difference between the anticipated fill amount of receptacle 14 and an actual fill amount (an amount determined based on the weight or volume measured via sensor 42) determined at a time of servicing, the algorithm used to anticipate the fill rate of that receptacle 14 may be tuned to decrease the difference in future service events. For example, weightings used in the algorithm to adjust the influence of weather conditions, holidays, sales, etc. on fill rate, may be adjusted. In addition, based on the tracked location of vehicle 12, the lift arm movements, the increase in vehicle payload, the vibrational changes, etc., onboard and/or offboard controllers 30, 32 may conclude that the particular receptacle 14 was properly serviced according to the required window of conditions. Onboard and/or offboard controllers 30, 32 may then use this confirmation as a basis for reporting the service to the owner of the location, billing for the service, and extending payment to the haul contractor (Step 360).

The disclosed system may provide a number of benefits. For example, because only vehicles 12 (and not receptacles 14) may be equipped with sensors 42, a cost of system 36 and associated maintenance requirements may be low. In addition, system 36 may consider the primary factors affecting the fill rate of receptacles 14, thereby providing improved accuracy in the service need predictions of receptacles 14. Further, system 36 may be applicable to any type of waste receptacles, regardless of a receptacle configuration.

It will be apparent to those skilled in the art that various modifications and variations can be made to the disclosed system. Other embodiments will be apparent to those skilled in the art from consideration of the specification and practice of the disclosed system. It is intended that the specification and examples be considered as exemplary only, with a true scope being indicated by the following claims and their equivalents.

1. A management system for use with a vehicle configured to receive waste from a receptacle in a location, the management system comprising:
at least one sensor mountable onboard the vehicle and configured to generate a receptacle-specific signal indicative of a condition of the receptacle; and
a controller in communication with the at least one sensor, the controller being configured to:
receive information that is non-specific to the receptacle:
anticipate a service need of the receptacle based on the receptacle-specific signal and the information; and
selectively direct the vehicle to service the receptacle based on the service need,
wherein the information non-specific to the receptacle includes at least one of business information associated with the location, landfill information, or population demographics.

2. The management system of claim 1, wherein the information includes at least one of a weather condition, a traffic condition, a sales event, a holiday, or a demographic condition.

3. The management system of claim 1, wherein the controller is configured to determine a fill rate based on the receptacle-specific signal received over a period of time.

4. The management system of claim 1, wherein:
the controller is configured to anticipate the service need based on an algorithm stored in memory; and
the controller is further configured to:
determine an anticipated fill amount of the receptacle based on the algorithm;
determine an actual fill amount of the receptacle based on the receptacle-specific signal, and
selectively adjust the algorithm based on a comparison of the anticipated fill amount and the actual fill amount.

5. The management system of claim 1, wherein the controller is further configured to confirm servicing of the receptacle based on the receptacle-specific signal.

6. The management system of claim 5, wherein the controller is further configured to initiate billing of a customer for servicing of the receptacle based on the receptacle-specific signal.

7. The management system of claim 5, wherein the controller is further configured to initiate payment to a haul contractor based on the receptacle-specific signal.

8. The management system of claim 1, wherein the controller is further configured to: generate a window of conditions associated with servicing the receptacle based on the receptacle-specific signal and at least one of a configuration of the receptacle, a size of the receptacle, a weight of the receptacle, a location of the receptacle, an owner of the receptacle, and a historical fill rate of the receptacle; automatically solicit bids from a plurality of haul contractors based on the window of conditions; and automatically select a bid from one of the plurality of haul contractors.

9. The management system of claim 1, wherein the at least one sensor is one of a load cell, a force gauge, or a pressure sensor.

10. The management system of claim 1, wherein the at least one sensor is one of an acoustic sensor, an accelerometer, or a camera.

11. The management system of claim 1, further including an input device locatable onboard the vehicle, the input device configured to receive input from an operator of the vehicle indicative of observances made by the operator during servicing of the receptacle, wherein the controller is further configured to anticipate the service need of the receptacle based on the input.

12. The management system of claim 1, further including a locating device mountable onboard the vehicle and configured to generate location signals indicative of a location of the vehicle, wherein the controller is further configured to anticipate the service need of the receptacle based on the location signals.

13. A method for managing service of a waste receptacle in a location by a vehicle, the method comprising:
sensing from onboard the vehicle a condition of the waste receptacle;
receiving information that is non-specific to the waste receptacle;
automatically anticipating a service need of the waste receptacle based on the condition and the information; and
selectively directing the vehicle to service the waste receptacle based on the service need,
wherein the information non-specific to the receptacle includes at least one of business information associated with the location, landfill information, or population demographics.

14. The method of claim 13, wherein the information includes at least one of a weather condition, a traffic condition, a sales event, a holiday, or a demographic condition.

15. The method of claim 13, further including determining a fill rate of the waste receptacle based on the fill rate sensed over a period of time,

16. The method of claim 13, wherein:
anticipating the service need of the waste receptacle includes anticipating the service need based on an algorithm; and
the method further includes:
anticipating a fill amount of the waste receptacle based on the algorithm;
determining an actual fill amount based on the condition; and
selectively adjusting the algorithm based on a comparison of the anticipated fill amount and the actual fill amount.

17. The method of claim 13, further including:
confirming servicing of the waste receptacle based on the condition;
billing of a customer for servicing of the waste receptacle based on the condition; and
paying a haul contractor based on the condition.

18. The method of claim 13, further including generating a window of conditions associated with servicing the waste receptacle based on the condition and at least one of a configuration of the waste receptacle, a size of the waste receptacle, a weight of the waste receptacle, a location of the waste receptacle, an owner of the waste receptacle, and a historical fill rate of the waste receptacle.

19. The method of claim 18, further including:
automatically soliciting bids from a plurality of haul contractors based on the window of conditions;
automatically selecting a bid from one of the plurality of haul contractors; and
confirming completion of servicing of the waste receptacle based on the condition.

20. A non-transitory computer readable medium containing computer-executable programming instructions for performing a method of management of a waste receptacle in a location by a vehicle, the method comprising:
sensing from onboard the vehicle a condition of the waste receptacle;
receiving information that is non-specific to the waste receptacle, including at least one of a weather condition, a traffic condition, a sales event, a holiday, or a demographic condition;
determining a fill rate of the waste receptacle based on the condition sensed over a period of time; and
automatically anticipating a service need of the waste receptacle based on the condition, the fill rate, and the information, wherein the information non-specific to the receptacle includes at least one of business information associated with the location, landfill information, or population demographics.
